(19) United States
(12) Patent Application Publication
(10) Pub. No.: US 2023/0223661 A1
(43) Pub. Date: Jul. 13, 2023

(54) VEHICLE BATTERY PACK

(71) Applicants: Hyundai Motor Company, Seoul (KR); Kia Corporation, Seoul (KR)

(72) Inventor: Kyung Mo KIM, Hwaseong-si (KR)

(73) Assignees: Hyundai Motor Company, Seoul (KR); Kia Corporation, Seoul (KR)

(21) Appl. No.: 17/946,297

(22) Filed: Sep. 16, 2022

(30) Foreign Application Priority Data
Jan. 11, 2022 (KR) 10-2022-0004229

(51) Int. Cl. H01M 50/514; B60L 50/64; H01M 50/249; H01M 50/505; H01M 50/545

(52) U.S. Cl. CPC H01M 50/514; B60L 50/64; H01M 50/249; H01M 50/505; H01M 50/545; H01M 2220/20

(57) ABSTRACT

A vehicle battery pack includes a cell unit including a plurality of battery cells aligned and disposed in a lateral direction, a connection terminal exposed in a longitudinal direction of each battery cell; and a busbar disposed at each side of the cell unit, forming an electrical connection with each battery cell through the connection terminal, and including an exposed terminal portion formed at an upper side to switch a signal transmission direction of the connection terminal in a direction perpendicular to the battery cell.

### CROSS REFERENCE TO RELATED APPLICATION

The present application claims priority to Korean Patent Application No. 10-2022-0004229, filed Jan. 11, 2022, the entire contents of which is incorporated herein for all purposes by this reference.

### BACKGROUND OF THE PRESENT DISCLOSURE

### Field of the Present Disclosure

The present disclosure relates to a vehicle battery pack, and more particularly to a vehicle battery pack, in which a structure for cell units with a terminal exposed in an upward direction like a prismatic cell is applied to the existing battery pouch cell to achieve a cell to pack (CTP) structure, integrating functions of parts that form the vehicle battery pack to reduce the kind and number of parts, and maximizing a volume ratio of the battery cell to increase the travel distance of an electric vehicle.

### Description of Related Art

With a recent global trend of reducing carbon dioxide emissions, there is a significantly increasing demand for an electric vehicle that utilizes electrical energy stored in a battery or the like energy storage device to drive a motor and generate driving power, in place of a typical vehicle that employs an internal-combustion engine to generate driving power through the combustion of fossil fuels.

The performance of the electric vehicle is highly dependent on the capacity and performance of the battery or the like energy storage device that stores the electrical energy to be supplied to a drive motor.

In the vehicle battery that stores the electrical energy to be supplied to the motor to generate the driving power of the vehicle, the travel distance of the electric vehicle is varied depending on the energy volume ratios of battery cells. In other words, the more battery cells, the better the travel distance of the electric vehicle. Therefore, there is a need to place as many battery cells as possible in a provided space.

Conventionally, a battery cell, a battery module, a battery pack have been modularized to each include a cover and housing, thus occupy 45% of a provided space. The remaining 55% of the space, except for 45%, is occupied by mechanical parts for the rigidity of the vehicle, heat dissipating/cooling parts for cooling the battery, or parts for heat insulation/electric insulation from, the outside thereof, which are not related to battery capacity. Therefore, a conventional electric vehicle has a low energy volume ratio problem.

As an alternative to such a conventional battery cell shaped like a pouch, maximizing the volume occupied by the battery cells and the volume ratio of the battery cells has been on the rise.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle battery pack, in which a structure for cell units with a terminal exposed in an upward direction like a prismatic cell is applied to the existing battery pouch cell to achieve a cell to pack (CTP) structure, integrating functions of parts that form the vehicle battery pack to reduce the kind and number of parts, and maximizing a volume ratio of the battery cell to increase travel distance of an electric vehicle.

According to an exemplary embodiment of the present disclosure, a vehicle battery pack includes: a cell unit including a plurality of battery cells aligned and disposed in a lateral direction, and a connection terminal exposed in a longitudinal direction of each battery cell; and

a busbar disposed at each side of the cell unit, forming an electrical connection with each battery cell through the connection terminal, and including an exposed terminal portion formed at an upper side to switch a signal transmission direction of the connection terminal in a direction perpendicular to the battery cell.

The cell unit may include two battery cells aligned and disposed in the lateral direction thereof.

The vehicle battery pack may further include a compression pad between two neighboring battery cells to connect the battery cells.

The busbar may be bent and extended from a lateral surface thereof to an upper surface including an exposed terminal portion formed on the upper surface to switch the signal transmission direction of the connection terminal over to the direction perpendicular to the battery cell.

The vehicle battery pack may further include a busbar housing coupled to an internal side of the busbar and protruding in a widthwise direction of the battery cell, and supporting the busbar.

The vehicle battery pack may further include a busbar cover coupled to an external side of the busbar, including an insulating material and covering the busbar.

The vehicle battery pack may further include: a cell cover placed on the cell unit and formed to support an upper structure; and

a sidewall provided at each end portion of the battery pack and holding the battery pack and the cell cover.

The cell cover may include an aluminum material.

The side wall may apply pressure toward the battery pack while being in surface-contact with each end portion of the battery pack.

The cell cover may be bent and extended from the upper surface to the lateral surface, and formed with a fastening portion at a lengthwise end portion thereof to couple with the side wall by a bolt.

The vehicle battery pack may further include a sensing panel provided on the cell cover, and coupling with a connection busbar to electrically connected in series to the plurality of cell units and the battery pack.

The connection busbar may be welded to the sensing panel by a laser welding method.

The sensing panel may include a temperature sensor formed to collect the temperature data of the cell unit.

The sensing panel may include a connector formed to transmit voltage and collected temperature data of the cell unit to a cell management unit (CMU).

The busbar may include a plurality of exposed terminal portions to which the battery cells are respectively connected, the exposed terminal portion extending upward and including an end portion bent in the longitudinal direction of the battery cell.

The busbar housing may include a first end portion formed with a central separator so that the battery cells may be respectively accommodated at opposite sides of the separator, and a second end portion to which the busbar is coupled.

In the vehicle battery pack according to the present disclosure, a CTP structure is embodied based on a structure for cell units while exposing a terminal in an upward direction like a prismatic cell, integrating functions of parts that form the vehicle battery pack to reduce the kind and number of parts, and maximizing the volume ratio of the battery cells to increase the travel distance of an electric vehicle. Furthermore, cell swelling is controlled by a surface pressure applying method based on a cell cover.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is an exploded view of a vehicle battery pack according to the present disclosure.

FIG. 2 is a view exemplarily illustrating a cell array, a cell cover, and a sensing panel of FIG. 1.

FIG. 3 is a top view exemplarily illustrating a vehicle battery pack.

FIG. 4 is a view exemplarily illustrating a cell unit and a busbar in the vehicle battery pack.

FIG. 5 is a view exemplarily illustrating a busbar.

FIG. 6 is a view exemplarily illustrating a busbar by which a signal transmission direction of a connection terminal is switched over in a direction perpendicular to a battery cell.

FIG. 7 is a view exemplarily illustrating a coupling structure between a busbar housing and a busbar and a busbar cover.

FIG. 8 is a view exemplarily illustrating a busbar cover in detail.

FIG. 9 is a view exemplarily illustrating a connection structure of a battery pack to be put into a vehicle body.

FIG. 10 is a view exemplarily illustrating a cell cover and a side wall in detail.

FIG. 11 is a view exemplarily illustrating a side wall applying pressure toward the battery pack while being in surface-contact with each end portion of a battery pack.

FIG. 12 is a view exemplarily illustrating a side wall holding a battery pack and a cell cover.

FIG. 13 is a view exemplarily illustrating fastening portions to couple with a side wall by bolts.

FIG. 14, FIG. 15 and FIG. 16 are views exemplarily illustrating a sensing panel in detail.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Regarding embodiments of the present disclosure included in the present specification or application, the specific structural or functional description is merely illustrative for describing the exemplary embodiments of the present disclosure, and embodiments of the present disclosure may be implemented in various forms but not be construed as being limited to the exemplary embodiments set forth in the present specification or application.

Because the exemplary embodiments of the present disclosure may be variously modified and have various forms, specific exemplary embodiments will be illustrated in the drawings and described in detail in the present specification or application. However, it may be understood that embodiments of the present disclosure are intended not to be limited to the specific embodiments but to cover all modifications, equivalents or alternatives without departing from the spirit and technical scope of the present disclosure.

Unless defined otherwise, all terms used herein including technical or scientific terms have the same meanings as those generally understood by a person having ordinary knowledge in the art to which the present disclosure pertains. The terms such as those defined in generally used dictionaries are construed to have meanings matching that in the context of related technology, and unless clearly defined otherwise, are not construed to be ideally or excessively formal.

Below, the present disclosure will be described in detail by describing embodiments with reference to the accompanying drawings. Like reference numerals in the drawings refer to like numerals.

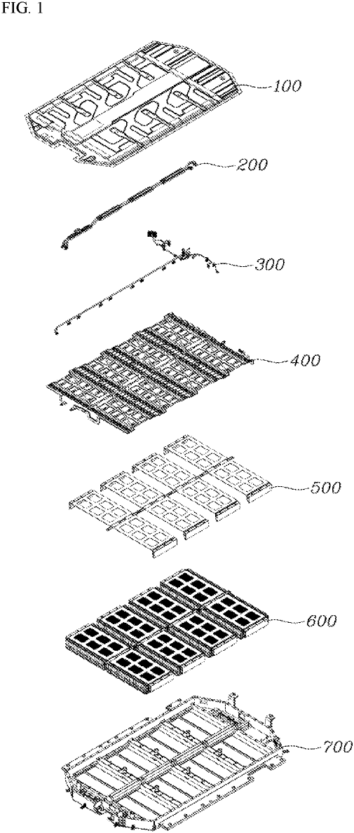

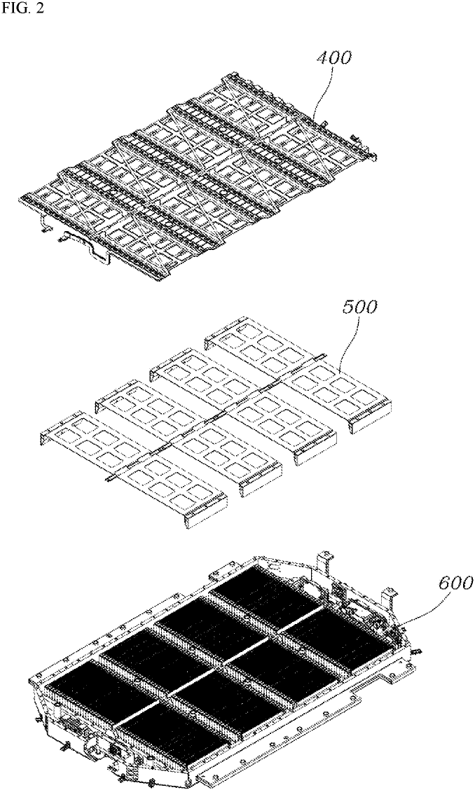

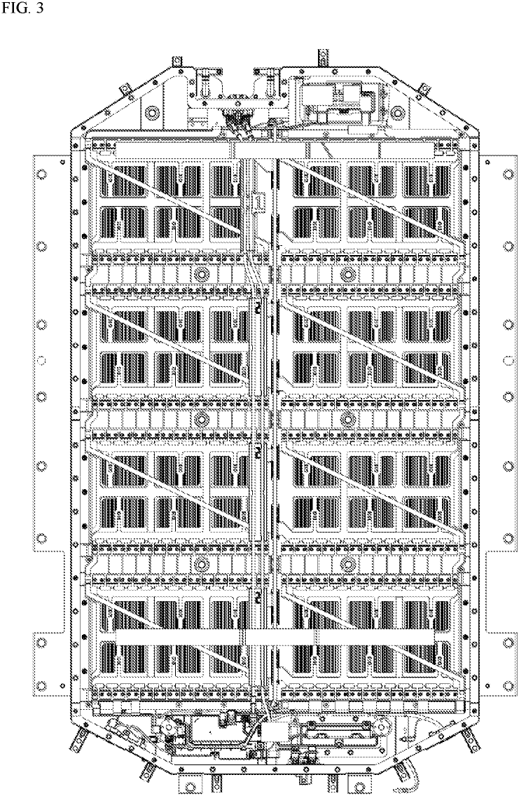

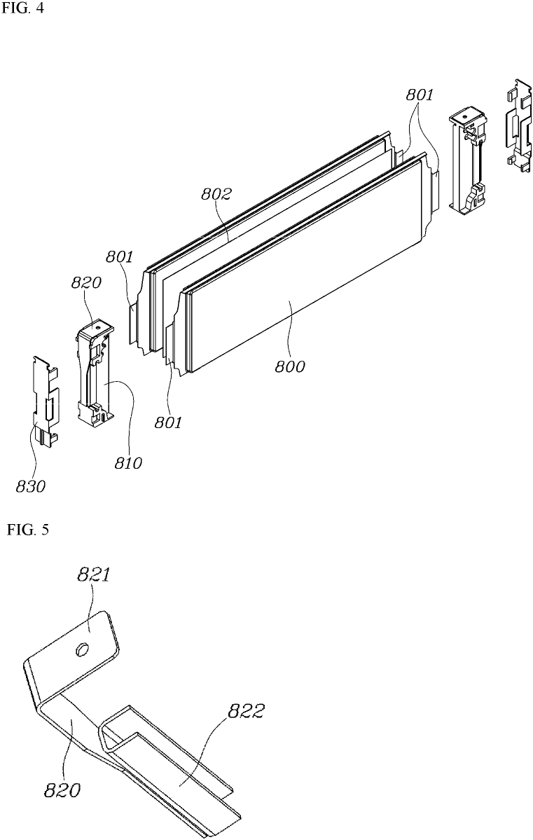

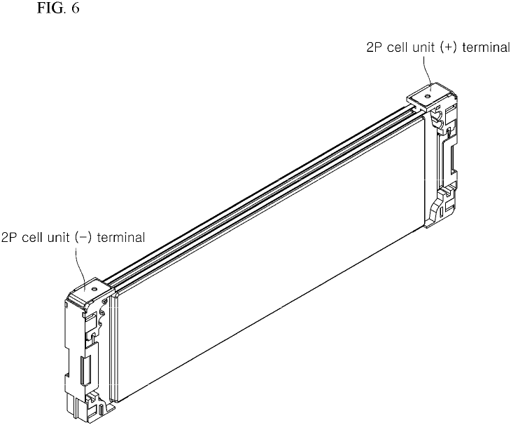

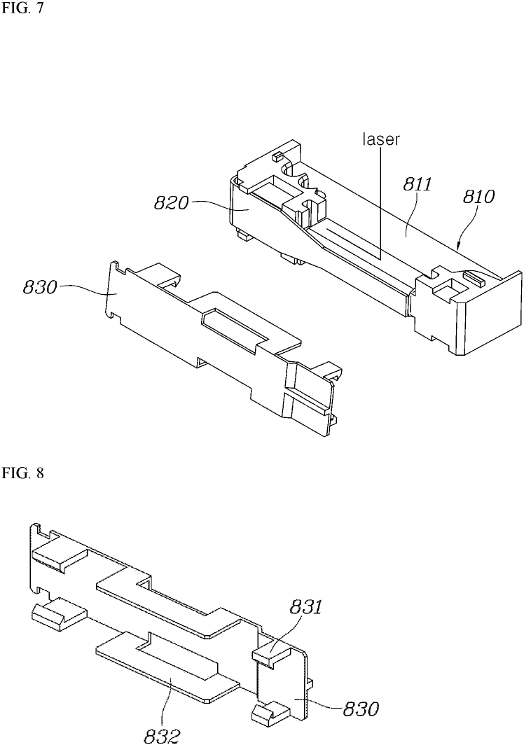

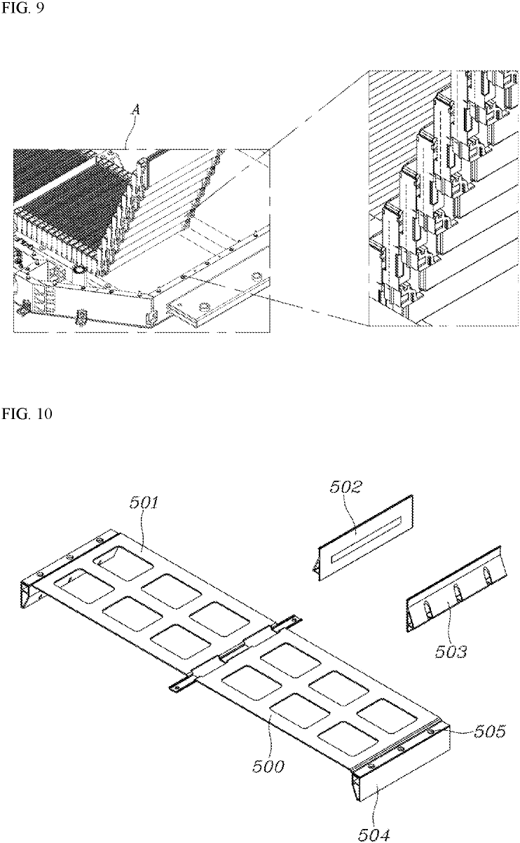

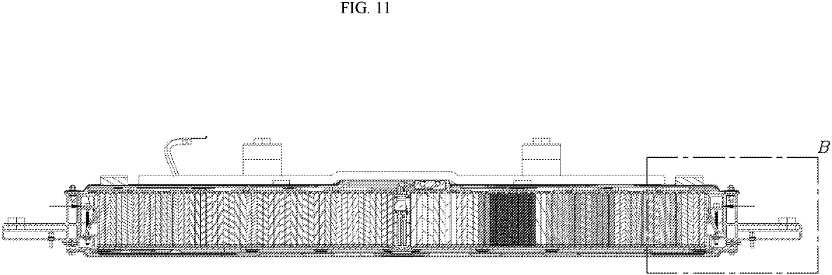

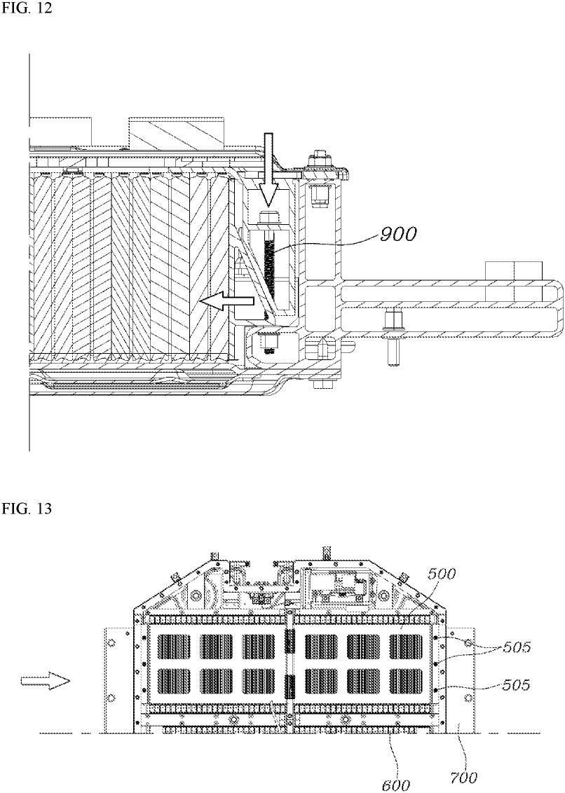

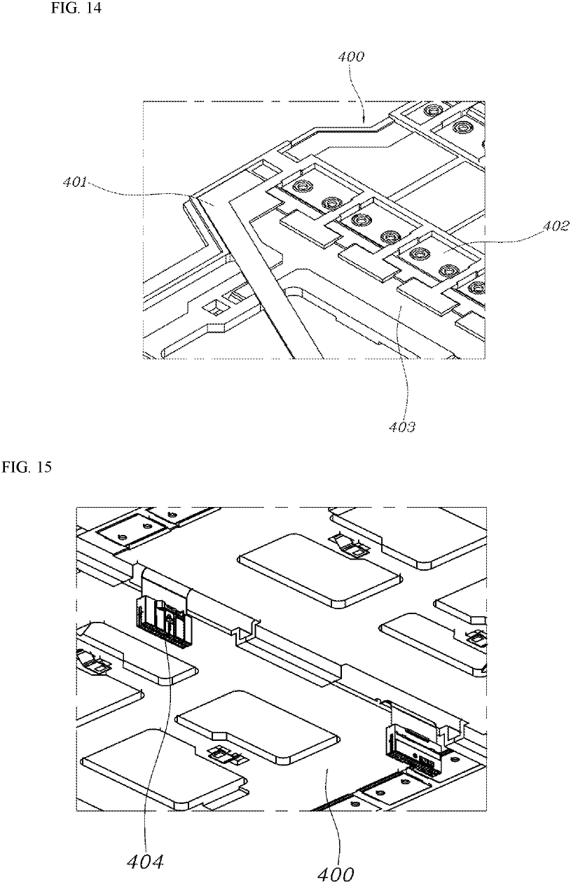

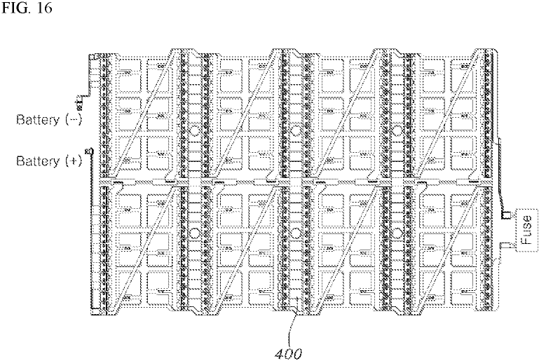

FIG. 1 is an exploded view of a vehicle battery pack according to the present disclosure. FIG. 2 is a view exemplarily illustrating a cell array, a cell cover, and a sensing panel of FIG. 1. FIG. 3 is a top view exemplarily illustrating a vehicle battery pack. FIG. 4 is a view exemplarily illustrating a cell unit 800 and a busbar in the vehicle battery pack. FIG. 5 is a view exemplarily illustrating a busbar. FIG. 6 is a view exemplarily illustrating a busbar by which a signal transmission direction of a connection terminal is switched over in a direction perpendicular to a battery cell. FIG. 7 is a view exemplarily illustrating a coupling structure between a busbar housing and a busbar, and a busbar cover. FIG. 8 is a view exemplarily illustrating a busbar cover in detail. FIG. 9 is a view exemplarily illustrating a connection structure of a battery pack to be put into a vehicle body. FIG. 10 is a view exemplarily illustrating a cell cover and a side wall in detail. FIG. 11 is a view exemplarily illustrating a side wall applying pressure toward the battery pack while being in surface-contact with each end portion of a battery pack. FIG. 12 is a view exemplarily illustrating a side wall holding a battery pack and a cell cover. FIG. 13 is a view exemplarily illustrating fastening portions to couple with a side wall by bolts. FIG. 14, FIG. 15 and FIG. 16 are views exemplarily illustrating a sensing panel in detail.

FIG. 1 is an exploded view of a vehicle battery pack according to the present disclosure. Furthermore, FIG. 2 is a view exemplarily illustrating a cell array 600, a cell cover 500, and a sensing panel 400 of FIG. 1. Furthermore, FIG. 3 is a top view exemplarily illustrating a vehicle battery pack.

Referring to FIGS. 1, 2, and 3, the vehicle battery pack includes a cell unit including a plurality of battery cells arrayed in a lateral direction, and a connection terminal 801 exposed in a longitudinal direction of each battery cell; and a busbar 820 provided at each side of the cell unit, forming an electrical connection with each battery cell through the connection terminal 801, and including an exposed terminal portion 821 formed at an upper side to switch a signal transmission direction of the connection terminal 801 in a direction perpendicular to the battery cell.

An overall structure according to the present disclosure includes an upper casing 100, a high voltage (HV) wire 200, a low voltage (LV) communication cable 300, the sensing panel 400, the cell cover 500, the cell array 600, and a lower casing 700 in sequence from top to bottom thereof.

The present disclosure is characterized in that a cell to pack (CTP) structure is embodied based on a structure for cell units while exposing a terminal in an upward direction like a prismatic cell, integrating functions of parts that form the vehicle battery pack to reduce the kind and number of parts, and maximizing the volume ratio of the battery cells. The battery cells are stacked to make up a battery module, and the battery modules are stacked to make up a battery pack. The battery pack is disposed in a lower portion of a vehicle body of the electric vehicle, supplying power to the vehicle and thus determining travel distance.

Thus, according to the present disclosure, a structure is introduced to have advantages of a prismatic cell in addition to the existing structure by moving a connection terminal 801 of a battery pouch cell to the top, and coupling with the busbar 820 for electrical parallel connection between the battery cells,

Recently, a prismatic cell-based battery system has already been embodied to have the CTP structure, and is being rapidly mass-produced. However, a pouch cell-based CTP structure has not been mass-produced all over the world. In the prismatic cell-based battery system, each individual unit cell is sealed with a can casing, and forms a rigid body in units of cells. Furthermore, each cell’s electrode terminals (+/- polarities) are exposed upward, so that the busbar 820 may be connected in a post-process after only the battery cell is first accommodated on a battery pack tray. However, compared with the pouch cell, the prismatic cell-based battery system has many coupling processes between the terminal of the battery cell and the electrode tab inside the battery cell. Therefore, it is easy for the prismatic cell-based battery system to have a CTP structure.

However, the pouch cell-based battery system unavoidably needs an intermediate structure of the battery module before making up the battery system because each unit cell is sealed with only a flexible and thin pouch. Furthermore, the electrode terminals (+/- polarities) of each individual cell are exposed in the longitudinal direction of the cell, and therefore the battery cells are grouped into the battery module and sensed before being inserted into the battery pack tray. Furthermore, the intermediate structure where the terminal is exposed to the top in units of the battery modules by welding the lead of the battery cell to the busbar 820 is unavoidable, and it is therefore difficult for the pouch cell-based battery system to have the CTP structure.

Accordingly, the present disclosure is to form a pouch cell-based battery pack structure suitable for the CTP structure, which employs a structure where the terminal of the battery cell is changed in the exposure direction, and at the same time, minimizes a duplicated function of mechanical rigidity between the battery cells in a conventional pouch cell-based battery system, and maximizes the volume occupied by the cells and the volume ratio of the cells in the electric vehicle and extremely simplifies the battery assembling process while maintaining the same cooling/insulating/mechanical durable performance by developing/applying an integrated battery pack part having multi-functions such as a cooling function/cell housing function/mechanical rigidity function, etc.

FIG. 4 is a view exemplarily illustrating a cell unit 800 and a busbar 820 in the vehicle battery pack. Furthermore, FIG. 9 is a view exemplarily illustrating a connection structure of a battery pack to be put into a vehicle body. The cell unit includes the plurality of battery cells arrayed in a lateral direction, and a connection terminal 801 exposed in the longitudinal direction of each battery cell. The battery cells are aligned and disposed in the lateral direction thereof. The battery cells are electrically connected in parallel and coupled to the busbar 820. The cell unit may be characterized in that two battery cells are aligned and disposed in the lateral direction thereof. The busbar 820 may be coupled to each end portion of the cell unit. Furthermore, the number of battery cells that make up the cell unit is not limited to two, but parts for cell units, which may be configured in units of cell, will be described below by way of example. Furthermore, a compression pad 802 for connecting the battery cells may be disposed between two neighboring battery cells. Heat or shock generated between the battery cells may be absorbed to some extent.

FIG. 6 is a view exemplarily illustrating a busbar by which a signal transmission direction of a connection terminal 801 is switched over in a direction perpendicular to a battery cell.

Referring to FIG. 6, the busbar 820 is disposed at each side of the cell unit and electrically connected to each battery cell through the connection terminal 801, and includes an exposed terminal portion 821 formed at an upper side so that the signal transmission direction of the connection terminal 801 may be switched over to the direction perpendicular to the battery cell. A pouch cell-based battery system unavoidably includes a battery module formed as an intermediate structure. On the other hand, when the signal transmission direction of the connection terminal 801 is switched over to the direction perpendicular to the battery cell, it is easy to form the CTP structure without forming the battery module.

Furthermore, the busbar 820 is shaped to be bent and extend from a lateral surface thereof to an upper surface, and is formed with the exposed terminal portion 821 on the upper surface so that the signal transmission direction of the connection terminal 801 may be switched over to the direction perpendicular to the battery cell. In the instant case, an electrical signal from the battery cell may be transmitted and received through a hole of the exposed terminal portion 821.

In other words, the busbars 820 are shaped to include the plurality of exposed terminal portions 821 to which the battery cells are connected, and the exposed terminal portion 821 extends upward and has an end portion bent in the longitudinal direction of the battery cell, achieving the CTP structure where functions of parts that form the vehicle battery pack are integrated to reduce the kind and number of parts, and allows realizing the CTP structure having the volume ratio of the battery cell maximized.

FIG. 7 is a view exemplarily illustrating a coupling structure between the busbar housing 810 and the busbar 820, and a busbar cover 830, and FIG. 8 is a view exemplarily illustrating the busbar cover 830 in detail.

Referring to FIGS. 7 and 8, the busbar housing 810 is coupled to an internal side of the busbar 820, protrudes in a widthwise direction of the battery cell, and is structured to support the busbar 820, and the busbar cover 830 is coupled to an external side of the busbar 820, made of an insulating material, and structured to cover the busbar 820.

In the instant case, the busbar housing 810 has a first end portion formed with a central separator 811 so that the battery cells may be respectively accommodated at opposite sides of the separator, and a second end portion to which the busbar 820 is coupled. Furthermore, the busbar housing 810 is structured to engage with the busbar 820, and the busbar cover 830 is structured to protect the busbar 820 against external shock from outside the busbar 820, in the longitudinal direction of the battery cells. The busbar cover 830 includes a hook 831 and a covering structure 832, is coupled to the busbar housing 810 by the hook 831 with the busbar 820 therebetween, and is configured for protecting the busbar 820 and the connection terminal 801 by the covering structure 832 made of insulating material.

FIG. 10 is a view exemplarily illustrating a cell cover 500 and side walls 502 and 503 in detail. FIG. 11 is a view exemplarily illustrating the side walls 502 and 503 applying pressure toward the battery pack while being in surface-contact with each end portion of a battery pack.

Furthermore, there may be provided the cell cover 500 placed on the cell unit and formed to support an upper structure; and the side walls 502 and 503, respectively provided at opposite end portions of the battery pack and holding the battery pack and the cell cover 500. The upper structure refers to all the elements disposed above the cell cover 500, which include the upper casing 100, the HV wire 200, the LV communication cable 300, and the sensing panel 400.

The side walls 502 and 503 may hold the battery pack and the cell cover 500 by a bolt fastening structure 900, and the cell cover 500 may be formed as a press plate 501 made of aluminum, of which weight is light relative to rigidity, in consideration of the weight of the vehicle.

Furthermore, the cell cover 500 dissipates heat generated in the battery pack through the holes. Referring to FIG. 12, and FIG. 13, the cell cover 500 is formed with fastening portions 505 at the lengthwise end portions thereof to couple with the side walls 502 and 503 by bolts, further increasing the rigidity. The fastening portion 505 may be fastened by the bolts at an extruded material 504 bent and extending from the upper surface to the lateral surface of the cell cover 500. In the instant case, the side walls 502 and 503 may apply force toward the battery pack while being in surface-contact with both end portions of the battery pack. The cell cover 500 is designed to apply a pressure of 90kgf in a surface direction between the battery cells in surface direction as being put down after the cell unit is put into the battery lower casing 700, increasing the rigidity.

FIG. 14, FIG. 15 and FIG. 16 are views exemplarily illustrating the sensing panel 400 in detail.

Referring to FIG. 14, FIG. 15 and FIG. 16, there may be provided the sensing panel 400 disposed above the cell cover 500, and including the connection busbars 820, 401, and 402 coupled to be electrically connected in series to the plurality of cell units and the battery pack.

The connection busbar 820, 401, and 402 may be welded to the sensing panel 400 by a laser welding method. The laser welding method in a weld 822 may be based on a technique of overlapping basic materials, and the opposite end portions of the sensing panel 400 may be connected to a fuse and a power relay assembly (PRA), achieving the electrical connection of the battery system. The connection busbar 820, 401, and 402 may be made of copper or aluminum to cope with high voltage and large current. The connection busbar 820, 401, and 402 for serial connection between the plurality of cell units, and the connection busbar 820, 401, and 402 for serial connection with the battery pack are provided to transmit the electrical signal of the vehicle in up and down directions and in left and right directions. Furthermore, the sensing panel 400 is formed with a temperature sensor 403 for collecting temperature data of the cell units. Because the sensing panel 400 is placed on the cell array 600, the temperature sensor 403 can detect the temperature of the cell unit while being in close contact with the top of the cell unit. Furthermore, the sensing panel 400 may be provided with a connector 404 for transmitting the voltage and collected temperature data of the cell unit to a cell management unit (CMU, Not illustrated), in which the voltage and the collected temperature data of the cell unit are required to undergo manual connection. Cell management unit(CMU) may be formed in the lower casing 700.

In a vehicle battery pack according to the present disclosure, a CTP structure is embodied based on a structure for cell units while exposing a terminal in an upward direction like a prismatic cell, integrating functions of parts that form the vehicle battery pack to reduce the kind and number of parts, and maximizing the volume ratio of the battery cells to increase the travel distance of an electric vehicle. Furthermore, cell swelling is controlled by a surface pressure applying method based on a cell cover.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of predetermined exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle battery pack comprising:
a cell unit including a plurality of battery cells aligned and disposed in a lateral direction, and a connection terminal exposed in a longitudinal direction of each battery cell; and
a busbar disposed at each side of the cell unit, forming an electrical connection with each battery cell through the connection terminal, and including an exposed terminal portion formed at an upper side to switch a signal transmission direction of the connection terminal in a direction perpendicular to each battery cell.

2. The vehicle battery pack of claim 1, wherein the cell unit includes two battery cells aligned and disposed in the lateral direction.

3. The vehicle battery pack of claim 2, further including a compression pad between two neighboring battery cells to connect the battery cells.

4. The vehicle battery pack of claim 1, wherein the busbar is bent and extends from a lateral surface thereof to an upper surface, and includes an exposed terminal portion formed on the upper surface to switch the signal transmission direction of the connection terminal to a direction perpendicular to each battery cell.

5. The vehicle battery pack of claim 1, further including a busbar housing coupled to an internal side of the busbar, and protruding in a widthwise direction of each battery cell, and supporting the busbar.

6. The vehicle battery pack of claim 1, further including a busbar cover coupled to an external side of the busbar, including an insulating material, and covering the busbar.

7. The vehicle battery pack of claim 6, further including:
a busbar housing coupled to an internal side of the busbar, and protruding in a widthwise direction of each battery cell, and supporting the busbar,
wherein the busbar cover includes a hook and a covering structure and is coupled to the busbar housing by the hook with the busbar therebetween, for protecting the busbar and the connection terminal by the covering structure.

8. The vehicle battery pack of claim 7, wherein the covering structure is made of the insulating material.

9. The vehicle battery pack of claim 1, further including:
a cell cover placed on the cell unit and formed to support an upper structure; and
a side wall provided at each end portion of the battery pack and holding the battery pack and the cell cover.

10. The vehicle battery pack of claim 9, wherein the cell cover is made of an aluminum material.

11. The vehicle battery pack of claim 9, wherein the side wall is configured to apply pressure toward the battery pack while being in surface-contact with each end portion of the battery pack.

12. The vehicle battery pack of claim 9, wherein the cell cover is bent and extends from the upper surface to a lateral surface, and formed with a fastening portion at a lengthwise end portion thereof to couple with the side wall by a bolt.

13. The vehicle battery pack of claim 9, further including a sensing panel provided on the cell cover, and coupling with a connection busbar to be electrically connected in series to a plurality of cell units and the battery pack.

14. The vehicle battery pack of claim 13, wherein the connection busbar is welded to the sensing panel by a laser welding method.

15. The vehicle battery pack of claim 13, wherein the sensing panel includes a temperature sensor formed to collect temperature data of the cell unit.

16. The vehicle battery pack of claim 13, wherein the sensing panel includes a connector formed to transmit voltage and collected temperature data of the cell unit to a cell management unit.

17. The vehicle battery pack of claim 1, wherein the busbar includes a plurality of exposed terminal portions to which each battery cell is respectively connected, the exposed terminal portions extending upward and including an end portion bent in a longitudinal direction of each battery cell.

18. The vehicle battery pack of claim 5, wherein the busbar housing includes a first end portion formed with a central separator so that each battery cell is respectively accommodated at opposite sides of the separator, and a second end portion to which the busbar is coupled.
